(19) United States
(12) Patent Application Publication
(10) Pub. No.: US 2008/0289470 A1
(43) Pub. Date: Nov. 27, 2008

(54) Bolt Lock For Saw Blades

(75) Inventor: James Aston, Monclova, OH (US)

Correspondence Address: RANKIN, HILL & CLARK LLP, 925 EUCLID AVENUE, SUITE 700, CLEVELAND, OH, 44115-1405, US

(73) Assignee: DIAMOND PRODUCTS, LIMITED, Elyria, OH (US)

(21) Appl. No.: 12/136,106

(22) Filed: Jun. 10, 2008

Related U.S. Application Data
(63) Continuation-in-part of application No. 11/950,766, filed on Dec. 5, 2007.
(60) Provisional application No. 60/873,660, filed on Dec. 8, 2006.

(51) Int. Cl. B26D 7/26

(52) U.S. Cl. 83/698.41

(57) ABSTRACT

A bolt lock is described for attachment to a blade collar of a concrete saw. The bolt lock stabilizes the position of a blade collar mounting bolt thereby preventing the bolt from loosening, which could otherwise result in the blade disengaging from the concrete saw.

### CROSS REFERENCES TO RELATED APPLICATIONS

This application is a continuation-in-part of U.S. application Ser. No. 11/950,766 filed Dec. 5, 2007 which claims priority to provisional application Ser. No. 60/873,660 filed Dec. 8, 2006, both of which applications are incorporated herein by reference.

### BACKGROUND OF THE INVENTION

1. Field of the Invention

The present invention relates to a bolt lock for attachment to a blade collar typically used in a saw utilizing a circular blade. In particular, the bolt lock stabilizes the position of a blade collar bolt which secures the blade collar and blade in a typical concrete saw.

2. Description of Related Art

Concrete saws typically use a circular blade having a cutting edge formed along the perimeter or peripheral edge of the blade. The blade is engaged to a powered rotating shaft by a blade collar. The blade is rotated at relatively high speeds and used in either wet or dry applications as desired.

The blade collar is typically a circular plate that is positioned adjacent to the blade when engaged to the rotating shaft of the saw. The blade is disposed between the saw and the collar and secured to the shaft by a threaded mounting bolt.

Incidents can occur in which the mounting bolt becomes loose, resulting in damage. Diamond saw blades on large concrete saws can spin at over two thousand revolutions per minute. The saw blades can be as large as 60 inches in diameter and weigh in excess of 100 pounds. If a blade becomes loose from a concrete saw it has the potential to be a problem. Many reasons exist for why blades become loose or completely detached from a concrete saw.

Concrete saw manufacturers traditionally use mounting bolts with left handed threads to hold the blade collars in place. Periodically, manufacturers of concrete saws either omit a lock washer. If a saw operator fails to sufficiently tighten the mounting bolt holding the blade collar properly or the threads are worn, the bolt has the potential to become loose.

Operators of concrete saws frequently remove and replace the diamond blades on their concrete saws. Instances may occur in which an operator will remove and replace different size blades in excess of 10 times during an eight hour period. Operators of concrete saws have a tendency to approach this casually and fail to realize the importance of proper torque when tightening the mounting bolt holding the blade collar in place.

Another reason for failure of engagement of the blade stems from inadequate operator training. Typically, specific instructions exist for blade use, replacement, and maintenance. This information should be communicated to all associated personnel. Even if supervisors have been sufficiently trained, workers in the field may not receive such training. Or, training efforts are not always continued so that after a period of time, new workers receive inadequate training or none at all.

Another reason for failure of blade engagement is that users fail to apply the 125 to 150 foot-pounds of torque suggested for tightening the mounting bolt.

Yet another reason for failure of blade engagement is that the split lock washers that some manufacturers provide with concrete saws are not replaced on a regular basis. Or, when they are replaced, the replacement is a standard washer typically carried at a hardware store and not a Grade 8 washer matched to the Grade 8 mounting bolt typically holding the collar.

Moreover, another reason for failure of blade engagement relates to operators not removing blade guards when replacing blades. Concrete saws typically include one or more blade guards that extend around a portion of the periphery of the blade and provide protection from the exposed cutting surface of the blade and debris generated during cutting. In order to reduce downtime when replacing a saw blade, certain operators do not remove the blade guards. While this may save time, it makes it difficult if not impossible to tighten the mounting bolt holding the collar, particularly using an open ended wrench supplied by many manufacturers.

Accordingly, a need exists for an assembly and method for preventing or at least significantly reducing the potential for, disengagement of rotating blades from saws, such as concrete saws.

### SUMMARY OF THE INVENTION

The difficulties and drawbacks associated with previous saw and blade mounting systems are overcome in the present apparatus for a bolt lock and associated assembly for securing a circular cutting blade to a saw.

In a first aspect, the present invention provides a bolt lock adapted for engagement alongside a blade collar securing a circular cutting blade to a rotating shaft of a saw. The bolt lock defines a first face to be directed toward the blade, an oppositely directed second face, and an outer edge extending between the first and second faces and extending about the outer periphery of the bolt lock. The bolt lock also defines a centrally disposed primary opening extending from the first face to the second face. The primary opening is sized and shaped to fittingly receive a mounting bolt attaching the blade and blade collar to the rotating shaft. The bolt lock further defines a secondary opening spaced radially from the center of the bolt lock.

In another aspect, the present invention provides a bolt lock assembly for securing engagement of a blade and blade collar with a rotating shaft of a saw. The bolt lock assembly comprises a bolt lock defining a first face to be directed toward the blade collar, an oppositely directed second face, and an outer edge extending between the first and second faces. The bolt lock also defines a central primary opening sized and shaped to fittingly receive a mounting bolt attaching the blade to the shaft of the saw. The bolt lock further defines a secondary opening spaced radially from the center of the bolt lock. The assembly also comprises at least one fastener extending through the secondary opening and threadedly received in the blade collar.

In yet another aspect, the present invention provides an assembly for securedly engaging a circular cutting blade to a rotating shaft of a saw. The assembly comprises a blade collar adapted to be positioned alongside the blade. The collar defines an inner face directed toward the blade, an oppositely directed outer face, a mounting aperture extending through a thickness of the collar and located at a center of the collar, and at least one threaded receiving aperture spaced from the center of the collar. The assembly also comprises a mounting bolt extending through the mounting aperture defined in the blade collar and engaging the blade collar and the blade to the shaft. The mounting bolt has a head accessible along the outer face of the blade collar. The assembly further comprises a bolt lock defining a first face to be directed toward the outer face of the blade collar, an oppositely directed second face, a central opening sized and shaped to fittingly receive the head of the mounting bolt, and a secondary opening spaced radially from a center of the bolt lock. And, the assembly comprises at least one fastener extending through the secondary opening defined in the bolt lock and threadedly received in the at least one receiving aperture defined in the blade collar.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a schematic partially exploded assembly view illustrating a typical concrete saw and a preferred embodiment bolt lock assembly in accordance with the present invention.

FIG. 2 is a perspective view of another preferred embodiment bolt lock in accordance with the present invention.

FIG. 3 is a front planar view of the bolt lock illustrated in FIG. 2.

FIG. 4 is a cross sectional view of the bolt lock depicted in FIG. 2, taken across section line AA in FIG. 3.

FIG. 5 is a front planar view of another preferred embodiment bolt lock in accordance with the present invention.

FIG. 6 is a cross sectional view of the bolt lock shown in FIG. 5, taken across section line BB in FIG. 5.

### DETAILED DESCRIPTION OF THE EMBODIMENTS

In accordance with the present invention, a bolt lock and associated assembly are provided. Preferably, the bolt lock is positioned over a mounting bolt holding a blade collar in place after the mounting bolt has been appropriately tightened. Preferably, the bolt lock defines an opening at the center of the bolt lock that is dimensioned such that it is slightly larger than the head of the mounting bolt. Preferably, a modified blade collar may also be provided in accordance with the present invention. The modified blade collar is preferably altered in two respects. First, the blade collar is modified or otherwise formed, so that a center region of the collar is flat. Secondly, one or more threaded receiving apertures are provided in the collar radially outward from the center of the collar. These threaded apertures receive one or more secondary bolts for securing the bolt lock to the blade collar. These aspects are all described in greater detail herein.

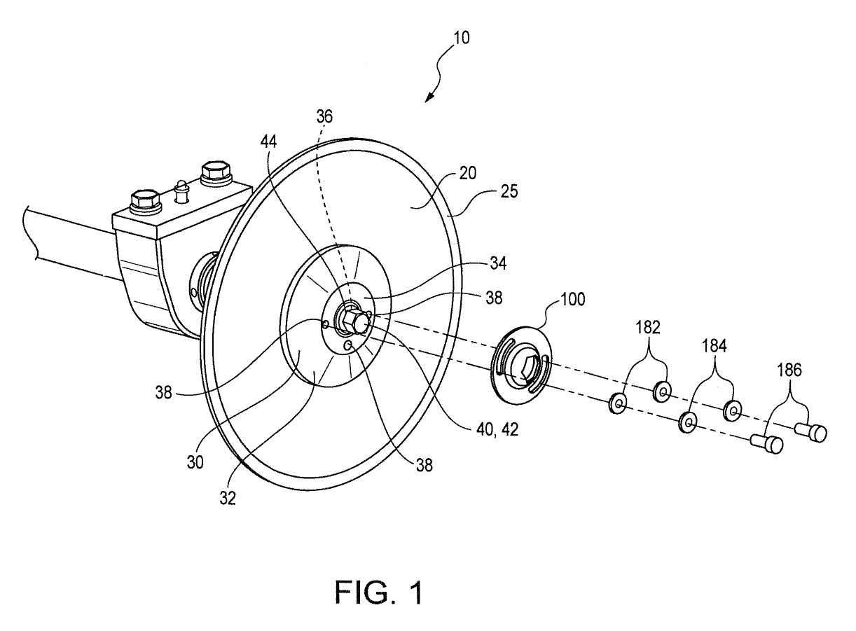

FIG. 1 is a schematic view illustrating a typical concrete saw 10 having a circular cutting blade 20. The cutting blade 20 includes an edge 25 or peripheral region containing cutting structures and/or abrasive material as known in the art.

The blade 20 is secured to a rotating powered shaft (not shown in FIG. 1) by a preferred embodiment blade collar 30, in accordance with the present invention. The preferred embodiment collar 30 is a circular member defining an outer face 32, an oppositely directed inner face (not shown), a central region 34, a central mounting aperture 36 extending through the thickness of the collar 30, and one or more threaded receiving apertures 38. The receiving apertures 38 are preferably spaced radially outward from the center of the collar. As evident in FIG. 1, the blade collar 30 is positioned alongside the blade 20, and preferably in contact therewith.

A mounting bolt 40 extends through the central mounting aperture 36 defined in the blade collar 30. As previously noted, such mounting bolts include a threaded engagement region, and traditionally these threads are left handed threads. The mounting bolt 40 is threadedly received in a corresponding female threaded receiving region (not shown) defined in the rotating shaft of the saw 10. The mounting bolt 40 includes a head 42 which typically is in the form of a hexagonal head. A lock washer 44 is preferably utilized between the underside of the head 42 and the outer face 32 of the preferred embodiment blade collar 30.

As noted, the preferred embodiment collar 30 also preferably defines one or more threaded receiving apertures 38 that are defined at a distance radially outward from the center of the collar 30. The one or more receiving apertures 38 are preferably threaded and receive a corresponding number of threaded male fasteners used in conjunction with the present invention bolt lock, and which are described in greater detail herein. The present invention includes a blade collar that is specifically formed or manufactured having these one or more threaded receiving apertures, or modifying a previously formed blade collar so as to include these one or more threaded receiving apertures. In the event that a previously formed blade collar, or existing blade collar is to be modified to include the receiving apertures, machining techniques can be used.

As noted, the preferred embodiment collar 30 also preferably defines a central region that is flat. That is, the central region preferably extends in a plane parallel to the rear face of the collar 30. Referring to FIG. 1, it is preferred that the central region 34 of the blade collar 30 be flat so as to provide a flat surface for the bolt lock 100 to be positioned adjacent thereto. The present invention includes a blade collar that is specifically formed or manufactured having this central flat region, or modifying a previously formed blade collar so as to exhibit this preferred flat central region. In the event that a previously formed blade collar, or existing blade collar is to be modified to exhibit this feature, machining techniques can be used to form the flat face.

FIG. 1 further illustrates a preferred embodiment bolt lock 100 in accordance with the present invention. The bolt lock, as described in greater detail herein, defines a central opening having dimensions and shaped so as to snugly receive the head 42 of the mounting bolt 40. The bolt lock 100 is positioned alongside the outer face 32 of the collar 30, and preferably, in contact therewith. The bolt lock 100 is preferably concentrically aligned with the blade collar 30. The bolt lock 100 defines one or more secondary openings, explained in greater detail herein, spaced radially outward from the center of the bolt lock that receive fasteners for securing the bolt lock 100 to the collar 30. Preferably, the fasteners may be in the form of fasteners 186 that extend through the secondary openings in the bolt lock 100 and are threadedly engaged with the blade collar 30, and specifically, within the threaded receiving apertures 38 defined therein. For each fastener 186, it is preferred to use an appropriately sized flat washer 182 adjacent to the bolt lock 100, and a lock washer 184 between the head of the fastener 186 and the flat washer 182.

FIGS. 2-4 illustrate another preferred embodiment bolt lock 200 in accordance with the present invention. The preferred bolt lock 200 defines an outer face 212, an oppositely directed inner face 210, and an arcuate edge 214 extending between the faces 210 and 212. The bolt lock 200 includes a raised center hub 220 that includes an arcuate wall 222 and an outwardly disposed center hub face 224. Defined within the hub face 224 is a primary opening 230 which is preferably sized and shaped to fittingly receive the head of a blade mounting bolt such as bolt 40 depicted in FIG. 1. The opening 230 is defined by an inner edge 232, which preferably defines a hexagon shape for the opening 230.

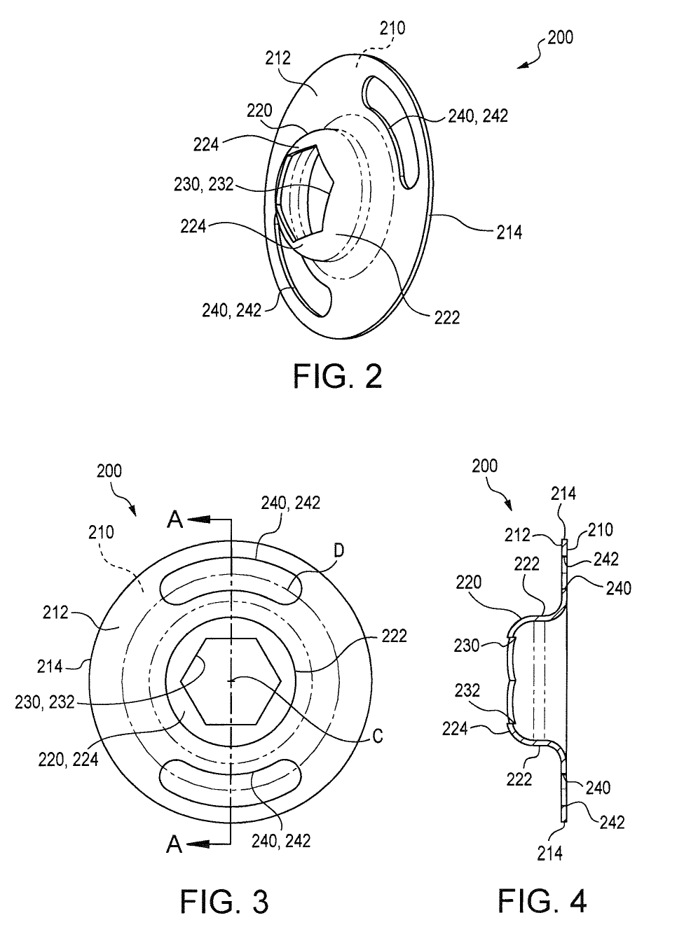

The preferred embodiment bolt lock 200 includes two secondary openings 240 defined by corresponding inner edges 242. Each of the openings 240 can be in any shape, however, a preferred shape is the slotted shape shown in FIGS. 2 and 3. Each of the openings 240 is sized so as to receive and allow the threaded region of a fastener, such as fastener 186 shown in FIG. 1, to extend therethrough. Each of the openings 240 is preferably in the form of an arcuate slotted aperture extending about the center of the bolt lock 200 by a constant radius. That is, the arcuate slot defines an arcuate major axis and the arcuate slot is defined such that the center point of the arcuate major axis coincides with the center of the bolt lock. Referring to FIG. 3, an arcuate major axis of arcuate slot 240 is designated as D. The center of the bolt lock is shown as C. Preferably, the arcuate major axis D extends about center C at a constant radius. The ends of each slotted aperture are preferably rounded as shown in the figures. Each opening 240 may extend about the center C of the bolt lock 200 by some angular amount, such as for example, from 60° to 90°, and preferably 60° when two slots are used. No matter how many slots are employed, the slots must extend a total of at least about 120°.

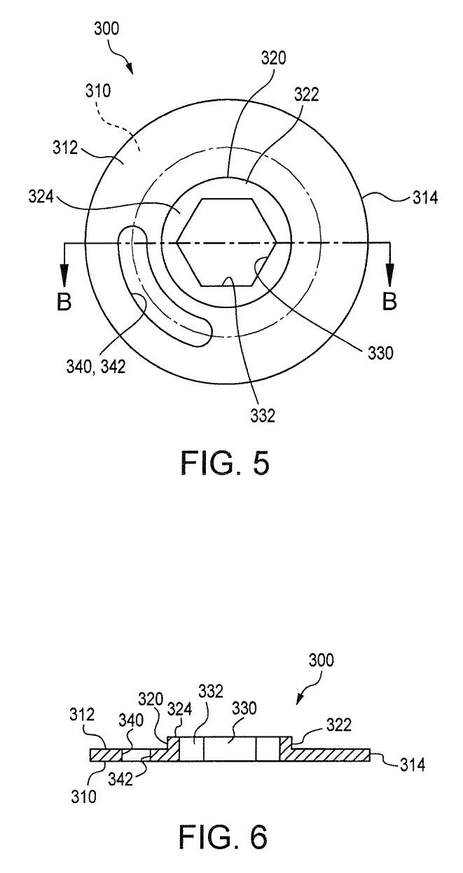

FIGS. 5-6 illustrate another preferred embodiment bolt lock 300 in accordance with the present invention. One difference between the bolt lock 300 of FIGS. 5-6 and the bolt lock 200 of FIGS. 2-4, is that the bolt lock 300 defines a single secondary opening 340. In addition, it is evident from a comparison of the two cross sectional views, i.e. FIGS. 4 and 6, that the bolt lock 300 features a raised center hub 320 that does not extend outward as much as the center hub 220 of the bolt lock 200. Referring to FIGS. 5-6, the bolt lock 300 defines an inner face 310 and an oppositely directed outer face 312. An arcuate edge 314 extends between the faces 310 and 312. The bolt lock 300 also includes a center hub 320 having an arcuate wall 322 and a center hub face 324. Defined within the center hub face 324 is a primary opening 330 for a mounting bolt. The primary opening 330 is defined by an inner edge 332 and is appropriately shaped and sized to fittingly receive the head of the mounting bolt. The bolt lock 300, as noted, defines a single secondary opening 340 which in turn is defined by an inner edge 342. The opening 340 is preferably similar the opening(s) 240 described in conjunction with the bolt lock 200. However, for bolt locks of the present invention having a single secondary opening, it is preferred that the opening extend about the center of the bolt lock for at least about 60°, and preferably about 75°.

Although the present invention bolt locks are not limited to the particular preferred embodiment bolt locks 100, 200, and 300 described herein and illustrated in the referenced figures, several additional preferences have been identified as follows. As noted, the secondary openings are preferably arcuate slots. A preferred radius of the arcuate centerline or major axis of these slots is about 1.0 to 3.0 inches from the center of the bolt lock. A preferred width for these slots is about 0.25 inches or slightly greater than 0.25 inches such as 5/16 inches. This enables the use of a 0.25 inch threaded fastener, such as fastener 186 shown in FIG. 1. The overall diameter of the preferred bolt lock is from about 2.0 to 4.0 inches and most preferably 3.0 to 3.25 inches. The primary opening defined in the center hub of the bolt lock is, as noted, sized and shaped to receive the head of the mounting bolt, such as bolt 40 in FIG. 1. Typically, the heads 42 of such bolts 40 are hexagonal heads having a size typically, of 15/16 or 1.0 inch. The primary opening in the bolt lock is sized slightly larger than the outer dimensions of the head of the mounting bolt, such as about 0.020 inches larger, so that the bolt head is snugly or fittingly received within the opening. The height of the raised center hub, relative to the outer face of the bolt lock is not critical, however 0.75 to 0.125 inches is typically suitable. The diameter of the center hub is typically from about 1.25 to 1.5 inches. The thickness of the bolt lock can be from about 0.05 to about 0.30 inches. It is to be understood that the present invention bolt locks are in no way limited to any of these various dimensions.

The present invention bolt locks can be made from a variety of materials, however, steel is preferred. The bolt locks can also be coated or otherwise provided with a desired outer surface. An anticorrosion outer layer is preferred, such as zinc plating for example.

The preferred embodiment bolt locks 100, 200, and 300 are used as follows. The operator tightens the mounting bolt holding the blade collar in accordance with instructions from the saw manufacturer. Specifically, the mounting bolt should be tightened to the manufacturer's specifications. As previously noted, most manufacturers recommend tightening such bolts to 125 to 150 foot-pounds of torque. Once the mounting bolt is in place and tightened, the operator positions the bolt lock in place. As previously described, the bolt lock preferably includes at least one arcuate slot extending about 1.5 inches from the center of the bolt lock, the slot being slightly larger than 0.25 inches wide. This slot extends about the center of the bolt lock through an arc of about 75 degrees. Regardless of the angular position of the head of the mounting bolt, the slot allows the operator to thread a 0.25 inch diameter bolt(s) into the blade collar having a corresponding threaded receiving aperture.

The bolt lock can easily be installed and removed very quickly, such as in about thirty seconds or less. The bolt lock is durable and will last for an extended period of time and through thousands of uses. When installed properly, the bolt lock will provide security insuring the mounting bolt holding the blade collar and blade will not disengage or become loose.

By incorporating the bolt lock into saws, potential liability can be significantly reduced. In addition, the use of the present invention bolt locks and related assemblies will improve overall safety.

The following publications illustrate typical concrete saws and blade provisions: US Patent Publication No. 2002/0117161 to Meister; US Patent Publication No. 2003/0168054 to Governo et al.; US Patent Publication No. 2004/0031475 to Markley; U.S. Pat. No. 5,743,247 to Kingsley et al; U.S. Pat. No. 6,019,433 to Allen; U.S. Pat. No. 6,855,039 to Vidmore; and PCT Patent Publication No. WO 2005/028287 to Iwata et al;

Many other benefits will no doubt become apparent from future application and development of this technology.

It is to be understood that the present invention includes embodiments having combinations of any of the various features and aspects described herein.

All patents, published applications, and articles noted herein are hereby incorporated by reference in their entirety.

As described hereinabove, the present invention solves many problems associated with previous type devices. However, it will be appreciated that various changes in the details, materials and arrangements of parts, which have been herein described and illustrated in order to explain the nature of the invention, may be made by those skilled in the art without departing from the principle and scope of the invention, as expressed in the appended claims.

I claim:

1. A bolt lock adapted for engagement alongside a blade collar securing a circular cutting blade to a rotating shaft of a saw, the bolt lock defining a first face to be directed toward the blade, an oppositely directed second face, and an outer edge extending between the first and second faces and extending about the outer periphery of the bolt lock, the bolt lock also defining a centrally disposed primary opening extending from the first face to the second face, the primary opening sized and shaped to fittingly receive a mounting bolt attaching the blade and blade collar to the rotating shaft, the bolt lock further defining a secondary opening spaced radially from the center of the bolt lock.

2. The bolt lock of claim 1 wherein the bolt lock comprises a raised center hub including a hub face and an arcuate wall extending between the hub face and the second face of the bolt lock, wherein the primary opening is defined in the hub face.

3. The bolt lock of claim 1 wherein the secondary opening is in the shape of a slot.

4. The bolt lock of claim 3 wherein the slot shape is arcuate.

5. The bolt lock of claim 4 wherein the arcuate slot defines an arcuate major axis, and the arcuate slot is defined such that the center point of the arcuate major axis coincides with the center of the bolt lock.

6. The bolt lock of claim 1 further defining a second secondary opening spaced radially from the center of the bolt lock.

7. A bolt lock assembly for securing engagement of a blade and blade collar with a rotating shaft of a saw, the bolt lock assembly comprising:
a bolt lock defining a first face to be directed toward the blade collar, an oppositely directed second face, and an outer edge extending between the first and second faces, the bolt lock also defining a central primary opening sized and shaped to fittingly receive a mounting bolt attaching the blade to the shaft of the saw, the bolt lock further defining a secondary opening spaced radially from the center of the bolt lock; and
at least one fastener extending through the secondary opening and threadedly received in the blade collar.

8. The bolt lock assembly of claim 7 wherein the at least one fastener includes a head, the assembly further comprising:
a locking member disposed between the second face of the bolt lock and the head of the fastener.

9. The bolt lock assembly of claim 7 wherein the bolt lock further defines a second secondary opening spaced radially from the center of the bolt lock, and the at least one fastener includes two fasteners, each fastener extending through a corresponding secondary opening and threadedly received in the blade collar.

10. The bolt lock assembly of claim 7 wherein the bolt lock comprises a raised center hub including a hub face and an arcuate wall extending between the hub face and the second face of the bolt lock, wherein the primary opening is defined in the hub face.

11. The bolt lock assembly of claim 7 wherein the secondary opening is in the shape of a slot.

12. The bolt lock assembly of claim 7 further defining a second secondary opening spaced radially from the center of the bolt lock.

13. An assembly for securedly engaging a circular cutting blade to a rotating shaft of a saw, the assembly comprising:
a blade collar adapted to be positioned alongside the blade, the collar defining an inner face directed toward the blade, an oppositely directed outer face, a mounting aperture extending through a thickness of the collar and located at a center of the collar, and at least one threaded receiving aperture spaced from the center of the collar;
a mounting bolt extending through the mounting aperture defined in the blade collar and engaging the blade collar and the blade to the shaft, the mounting bolt having a head accessible along the outer face of the blade collar;
a bolt lock defining a first face to be directed toward the outer face of the blade collar, an oppositely directed second face, a central opening sized and shaped to fittingly receive the head of the mounting bolt, and a secondary opening spaced radially from a center of the bolt lock; and
at least one fastener extending through the secondary opening defined in the bolt lock and threadedly received in the at least one receiving aperture defined in the blade collar.

14. The assembly of claim 13 wherein a centrally disposed portion of the outer face of the blade collar is flat and generally parallel with the inner face of the blade collar.

15. The assembly of claim 13 wherein the mounting bolt includes a threaded region, and the threads are left hand threads.

16. The assembly of claim 13 further comprising:
a locking member disposed between the head of the mounting bolt and the outer face of the blade collar.

17. The assembly of claim 13 wherein the bolt lock comprises a raised center hub including a hub face and an arcuate wall extending between the hub face and the second face of the bolt lock, wherein the primary opening is defined in the hub face.

18. The assembly of claim 13 wherein the secondary opening defined in the bolt lock is in the shape of a slot.

19. The assembly of claim 13 wherein the bolt lock further defines a second secondary opening spaced radially from the center of the bolt lock.

20. The assembly of claim 13 wherein the saw is a concrete saw.
